(19) United States
(12) Patent Application Publication
(10) Pub. No.: US 2007/0207679 A1
(43) Pub. Date: Sep. 6, 2007

(54) ELECTRIC CONTACT

(76) Inventors: Stephan KLEINSCHMIDT, Luebbecke (DE); Marco Tadje, Bad Nenndorf (DE)

Correspondence Address: HAYES SOLOWAY P.C., 3450 E. SUNRISE DRIVE, SUITE 140, TUCSON, AZ, 85718, US

(21) Appl. No.: 11/677,356

(22) Filed: Feb. 21, 2007

(30) Foreign Application Priority Data
Mar. 1, 2006 (DE) 20 2006 003 204.5

(51) Int. Cl. H01R 13/64

(52) U.S. Cl. 439/680

(57) ABSTRACT

In order to connect an electric PE contact with an electrically conductive connector housing, the invention proposes that the PE contact that is realized in the form of a pin or socket contact and arranged in a sleeve of an insulating supply insert is directly contacted with the connector housing and fixed by means of a screw connection.

For this purpose, the contact features a thickening that is arranged between its mating region and the connecting region, wherein said thickening directly adjoins an elevated shoulder in the connector housing through an opening in the sleeve.

### BACKGROUND OF THE INVENTION

1. Field of the Invention

The invention pertains to an electric contact in an insulating housing that features several sleeves and is connected to an electrically conductive housing by means of a screw connection.

An electric contact of this type is required for contacting a PE conductor or protective conductor with an electrically conductive metal housing.

2. Description of the Related Art

Electric contacts to be inserted into insulating connector inserts of a plug-type connector typically feature a mating region and a connecting region that is realized in the form of a screw connection, soldering connection or crimping connection.

However, such contacts cannot be used if a so-called PE contact is required as a protective measure against dangerous shock currents, e.g., when working with a 230 V operating voltage, wherein this contact produces an electric connection with a grounded point of a power source.

### SUMMARY OF THE INVENTION

The invention is based on the objective of realizing an electric contact of the initially cited type in such a way that it not only features a mating region and a crimping region for being connected to an electric conductor, but can also be securely connected to a surrounding electrically conductive housing.

This objective is attained in that the electric contact in the form of a pin or socket features a mating region and a connecting region, wherein the mating region and the connecting region are separated from one another by a thickening.

The advantages attained with the invention can be seen, in particular, in that a direct electric contact with a metallic housing is produced with the inventive electric contact, to which a so-called PE cable is crimped.

A PE cable of this type is required for producing an electric connection with a grounded point of a power source as a protective measure against dangerous shock currents.

In this case, a conventional pin or socket contact featuring a crimping connection is provided with an additional thickening, in which a threaded bore is arranged.

This contact is positioned in an electrically insulating supply insert that comprises several sleeves together with other contacts, wherein said supply insert is advantageously arranged in a metallic connector housing together with a plug-type data module.

In this case, the supply insert is provided for the power/voltage supply and the data module is provided for the transmission of signal voltages. It is advantageous that the electric contact makes it possible to produce a direct contact between the thickening and an elevation in the housing interior of the connector housing that surrounds the opening for the screw connection, namely by means of its threaded bore and a screw connection, wherein the electric contact extends through the respective connector housing.

It is also advantageous that the supply insert is provided with locking means that make it possible to produce a simple connection with a data module to be accommodated in the connector housing.

At least one of the interconnectable sleeve pairs is provided with corresponding polarization means in order to prevent a mismatched connection between both supply inserts.

### BRIEF DESCRIPTION OF THE DRAWINGS

One embodiment of the invention is illustrated in the figures and described in greater detail below. The figures show:

FIG. 1, is a connector housing that is provided with a flange and features two plug-type connector modules, wherein an inventive electric contact is arranged in one of the modules, and

FIG. 2 is a connector housing with two plug-type connector modules, wherein the inventive electric contact is arranged in one of the modules.

### DETAILED DESCRIPTION OF THE INVENTION

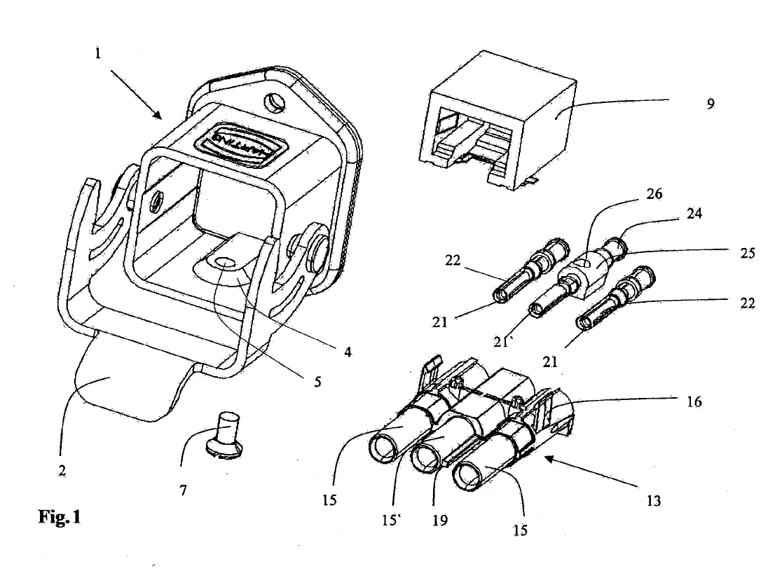

FIG. 1 shows the connector housing 1 that is provided with a screw-on flange and into which a connector set can be inserted that is composed of a so-called RJ-45 data module 9 in the form of a socket and a supply insert 13.

A locking clip 2 is also provided for fixing a mating connector 3.

The supply insert 13 is composed of an electrically insulating housing that consists of three adjacently arranged and interconnected sleeves 15, 15′, into which an electric contact 21, 21′ in the form of a socket contact can be respectively inserted. The contacts are conventionally fixed within the sleeves by means of (not-shown) check cones.

In this case, the central electric contact 21′ that is referred to as the PE contact has a peculiar feature, namely a thickening 24 that is arranged between the mating region 22 and the crimping region 23.

The thickening 24 contains a bore 26 that is provided with a thread.

The thickening may have any conceivable shape that ensures, for example, an unmistakable or polarizing arrangement of the contact within the sleeve.

The central sleeve 15′ accommodating the PE contact furthermore contains an opening 17 that corresponds to the thickening 24.

The supply insert 13 features two locking arms 16 that are respectively arranged on the outer sleeves 15, wherein the RJ-45 data module 9 can be inserted and locked in said arms.

After the assembly of the two different connector units, they need to be inserted into the connector housing 1.

The two connector units are fixed by means of a screw 7 that is screwed into the threaded bore 26 of the thickening 24 on the central contact 21′ from outside the connector housing 1, namely through an opening 5 provided therein.

Since the central contact accommodates a so-called PE conductor, a reliable direct electric contact is ensured by the surfaces between the PE contact 21′ and the metallic connector housing 1 in which a correspondingly designed elevated shoulder 4 is provided.

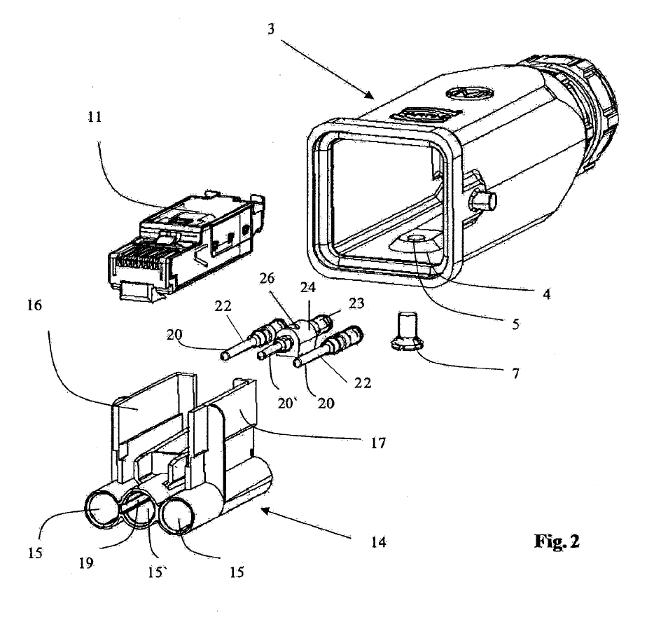

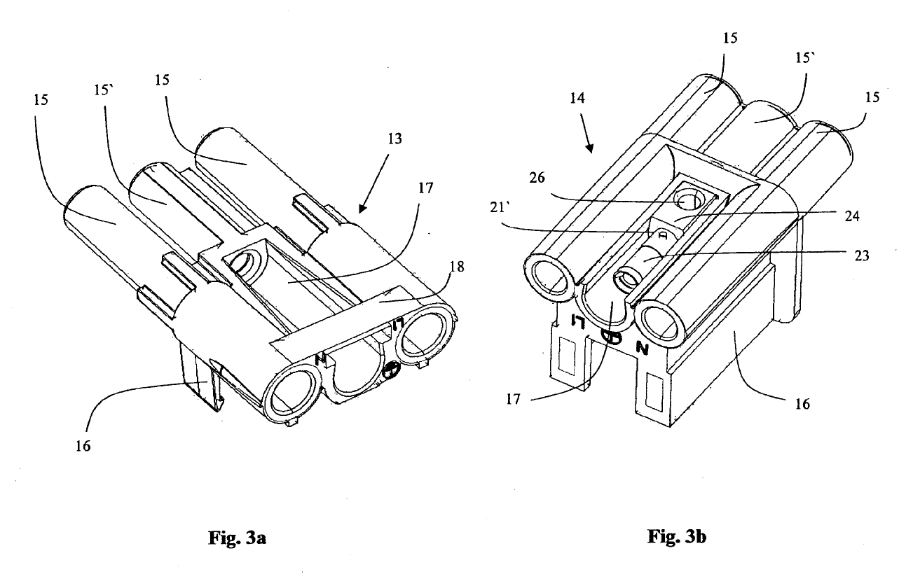

FIG. 2 shows a mating connector that corresponds to the flanged connector housing 1 according to FIG. 1 and features a connector housing 3 for accommodating the R J-45 data module 11 realized in the form of a plug as well as the supply insert 14.

Electric contacts 20, 20′ in the form of pins are inserted into the sleeves 15, to 15′ in this supply insert, wherein the specially designed central contact 20′ is positioned in the central sleeve 15′.

In order to accommodate the R J-45 data module 11, locking arms 16 are integrally moulded onto the outer sleeves 15′ in accordance with the shape of the data module.

The central contact 20′ of these pin contacts not only features a mating region 22 and a connecting region realized in the form of a crimping connection 23, but also a thickening 24 in which a threaded bore 26 is provided for fixing the supply insert 14 in the connector housing 3.

During the assembly, the data module 11 is engaged with the supply insert 14 and the interconnected unit is inserted into the connector housing 3 and fixed therein by means of the screw 7, wherein an electrically conductive contact between the pin contact 20′ and the connector housing 3 is simultaneously ensured.

FIG. 3a shows a supply insert 13 with sleeves 15, 15′ that are arranged in a row and serve for inserting socket contacts 21, 21′.

The oblong opening 17 in the central sleeve 15′ is covered with a web 18 on its open end, wherein the socket contact 21′ to be fitted therein is inserted underneath said web.

FIG. 3b shows the supply insert 14 with a view of the opening 18 in the central sleeve 15′, into which a socket contact 21′ is inserted with its mating side as far as the stop of the thickening 24. Due to the recessed arrangement of the pin or socket contacts 20, 21′ in the sleeves 15′, an elevated shoulder 4 is realized on the connector housings 1, 3 such that a direct contact is ensured between the thickenings 24 of the pin or socket contacts and the connector housings 1, 3.

What is claimed is:

1. An electric contact in an insulating supply insert that features several sleeves and can be connected to an electrically conductive connector housing by means of a screw connection, wherein
the electric contact in the form of a pin or socket comprises a mating region and a connecting region, wherein the mating region and the connecting region are separated from one another by a thickening.

2. The electric contact according to claim 1, wherein
a bore is provided within the thickening.

3. The electric contact according to claim 2, wherein
the bore features a thread.

4. The electric contact according to claim 1, wherein
the electric contact within the supply insert featuring several sleeves can be connected to the electrically conductive connector housing by means of a screw connection.

5. The electric contact according to claim 4, wherein
the central sleeve of the supply insert features polarization means.

6. The electric contact according to claim 4, wherein
locking arms are integrally moulded onto the supply insert.

7. The electric contact according to claim 4, wherein
the supply insert features a web.

8. The electric contact according to claim 1, wherein
the thickening on the electric contact can be contacted with the connector housing in an electrically conductive fashion through an opening provided for this purpose in the central sleeve.
